(19) United States
(12) Patent Application Publication
(10) Pub. No.: US 2007/0029040 A1
(43) Pub. Date: Feb. 8, 2007

(54) Method for the preparation of adhesive

(75) Inventor: Friedrich Struve, Rosenheim (DE)

Correspondence Address: BIRCH STEWART KOLASCH & BIRCH, PO BOX 747, FALLS CHURCH, VA, 22040-0747, US

(73) Assignee: Klebchemie M.G. Becker GMBH & Co. KG, Weingarten (DE)

(21) Appl. No.: 10/555,880

(22) PCT Filed: May 7, 2004
(86) PCT No.: PCT/DE04/00973

§ 371 Date: Sep. 15, 2006

(30) Foreign Application Priority Data
May 7, 2003 (DE) 103 20 581.0

(51) Int. Cl. C09J 5/04

(52) U.S. Cl. 156/314

(57) ABSTRACT

The invention relates to a method of adhesively bonding articles, in which an agent for preparation for bonding is applied and, prior to adhesive bonding, conditioning is performed. In this method it is envisaged that conditioning take place with brushing.

The present invention relates to what is claimed in the preamble and is concerned accordingly with the adhesive bonding of articles.

The adhesive bonding of articles in the industrial sphere is an operation requiring precision in order to achieve appropriate adhesive bonding results. For an effective bonding outcome it should be ensured in particular that bonding is uniform and permanent. Generally in many applications, such as in the bonding of plastics to one another, such as in the case of window profiles to which protective and/or decorative sheets are to be adhered, it is first of all necessary to pretreat the substrate in order to achieve good bonding results. In that case a material (primer) is applied which ensures that the adhesive for subsequent application forms an intimate bond with the plastic substrate of the base element. In the art this primer is typically applied by moving the article along on a conveyor belt at an applicator such as a felt wiper and thereafter, if necessary, evening out the applied material. Following exposure to the primer it is then possible for example to apply a wrapping using PU hotmelt adhesives or other materials.

Frequently it is then necessary to perform a certain kind of conditioning. With limited plant sizes and a given transport speed of the article to be prepared for bonding, however, there is a limit on the reaction time or exposure time available. Nor does anything different apply if the material to be applied is not a primer but rather an adhesive, which is intended to undergo partial drying, partial reaction or some other alteration in preparation for bonding.

With conventional primers based on volatile organic solvents it can be sufficient following application, in further preparation for bonding, to perform a conditioning consisting solely in an evening-out of the applied primer fluid and ensuring an adequate exposure time by transporting the primed profile or article over a certain distance at a given speed. Plant and methods with which this is the case are already known. Known systems also lead to acceptable adhesion results.

The use of primers based on volatile organic solvents, however, is increasingly unwanted, for a variety of reasons. The preference would be for adhesive bonds in which at least the primer is water-based or can be chosen to be water-based. Typically, however, in the case of water-based primers in conventional plant, the exposure time of the bonding preparation agent, between application and bonding, is too small and/or so great a quantity of material must be applied that, owing to the relatively low vapor pressures in existing plant, the material has not automatically dried to a sufficient extent when the time comes for bonding. Attention is drawn to, inter alia, DE 44 28 382 A1, which relates to an aqueous primer for apolar plastics such as PE, PP, EPDM etc. The primer is said to be applied by techniques such as spraying, pouring, fine brushing, rolling or dipping and then dried with hot air or infrared radiation, which is said to take usually 2-6 minutes. A disadvantage in this case is the long drying time.

In principle it would be possible to extend the construction length of existing plant. However, owing to the larger halls which would then be needed, this would lead to possibly considerable investment costs. Another possibility is to heat the profiles considerably after the agent has been applied in order to perform conditioning of a kind that makes adhesive bonding easier. It is disadvantageous, however, that in that case temperatures are often reached which are detrimental for subsequent bonding; in other words, temperatures which necessitate, in turn, a sufficient cooling time and hence longer transport paths on the conveyor belt for the article to be bonded, and/or that, particularly in the case of relatively thin profiles, deformation may occur, possibly to the point where the workpiece present becomes unusable.

It is desirable to alleviate, at least in part, at least some of the problems mentioned.

The object of this invention is to provide new subject matter for commercial application.

The achievement of this object is claimed in independent form. Preferred embodiments are found in the subclaims.

A first substantial aspect of the present invention consists, thus, in the finding that conditioning with brushing is advantageous in the case of articles particularly with a PVC surface and/or made of PVC and/or made of other plastics, especially polar plastics. In contrast to what is the case with conventional evening-out by means of felt wipers and the like, with brushing it is possible to obtain uniform and particularly effective conditioning even on profiles of complex shape composed of PVC and/or of other plastics, with grooves and the like, and the movement of brush relative to article produces particularly effective distribution and the like. This is possibly the case with water-based systems because in the case of brushes, as a result of the bristle arrangement, particularly in respect of the typical length and/or their denseness or thickness, the action of capillary force on the agent is different and more suitable than in the case of felt wipers. It is noted that typical brush movements over the article occur with a greater speed and/or under a higher applied pressure than, say, slow, manual fine-brush movements.

Depending on the design of the brush hardness and/or of the brush applied pressure, moreover, it is possible for slight roughening to occur, which particularly in the case of primers makes a further contribution to the desired, positive effect.

The adhesive bonding of articles typically involves two articles being bonded to one another areally, i.e., not merely punctually. With areal adhesive bonding it is particularly important for sufficiently uniform and constant bonding to be achieved over the area, and this is manifested in particular in good bonding outcomes. Thus it is possible in particular to achieve a high peel test strength.

Areal bonding may take place in particular as the wrapping of a substrate with a comparatively thin sheet. Here, typically, the substrate, which is relatively thick, is prepared and then an appropriate sheet is applied. The substrates in question may be PVC profiles, such as are customary in facing construction, windows, and the like.

The bonding and the preparation for bonding afford good results even when the article has corresponding profiling and possibly even articles already formed by coextrusion are prepared. Thus it is possible to provide sealing lips and the like in a profile intended for subsequent wrapping, and even in the case of complex-shaped articles of this kind the method of the invention affords good results.

Bonding will typically be performed on elongated articles, which are guided past the site of application of the agent, and at a place reached later on with the movement of the article a conditioning is performed.

The agent in question may in particular be a primer, more particularly a water-based primer. The conditioning of the invention makes it possible to ensure that an excess of remaining material does not adversely affect the adhesion outcome and/or that poor results are not achieved because of the application of too little material to start with.

It is possible and preferred first to apply the agent in excess, in particular as a fluid or liquid, and then to achieve conditioning by spreading and/or removing the agent or partially reacted agent.

Conditioning will typically encompass at least two separate conditioning steps: typically, first, the step of evening out the excess applied material and, secondly, the step of removing it. The conditioning performed for the purpose of evening-out may typically take place in a wet system, thereby ensuring that the amount of pretreating agent sufficient for evening out is available, whereas the removal of the excess takes place in a system which is merely moist; in other words, some of the material has already been taken away, evaporated or reacted. An approach of this kind with two different conditioning steps in a wet system and in a moist system requires on the one hand a movement section which is sufficient and yet not too long between the two stations at which the respective conditioning is performed, and hence ensures sufficiently long exposure of the applied agent, while on the other hand ensuring that it is not necessary to use a considerable excess of material.

Typically the brushes are not mounted in the movement track such that they are in simple scraping contact, but instead are at the same time moved in oscillation and/or rotation. This initially ensures that, as a result of the change in the position of the brush hairs, new capillary structures are formed continually, leading to more uniform spreading of the liquid on the brush and hence on the article. It is particularly preferable if the brushes are guided rotatingly over the surface of the article, since in that case even better evening-out is achieved. It is possible in particular to arrange a rotating brush in such a way that the axis is generally parallel with the plane along which the article is moved. In this arrangement, however, the brush axis will typically lie approximately transverse to the direction of movement, so that the article is in scraping contact with roughly tangential brush hairs. It should be mentioned that the movement over the article is not exactly tangential, particularly when relatively long brush hairs are bent over by the article.

The brush may circulate counter to the movement direction of the article, which for equal brush speed increases the relative movement and, moreover, has the effect of pushing back excess material in front of the brush contact point and therefore making conditioning easier. If two-stage brush conditioning with moving brushes is carried out, particularly for the purpose of evening-out and for removal of excess, the first brush can be moved more slowly than the second brush. In this way, removal with the rapid movement of the second brush is accomplished.

After the excess has been removed it is preferable further to perform a blow-off step or heating step, in which case further exposure to the increasingly concentrated primer is possible, and/or, for example, the simple taking away of drying after a given exposure time.

It may be mentioned that, as a water-based primer, the primer can be adapted to the method through, among other factors, the choice of concentration, agents for influencing the wetting characteristics, in order to ensure a sufficiently short evaporation time and yet to allow the material to be prepared.

The method is advantageous not only in the case of profiles of complex shape, with recesses and/or grooves, but is advantageous specifically in the case of elongated workpieces at the start area and end area, owing to profile guide tolerances and material tolerances that are present there, since these tolerances lead easily to an uneven treatment with preparation agent. Moreover, the accumulation of excess primer at hollow grooves and sealing profiles, or when two or more felts are used for complicated profiles with an overlapping region of contact, is prevented. The overall operational reliability goes up; operation can take place at a lower temperature and hence with a substantially lower supply of energy in manufacturing. At the same time, owing to the lower temperature, the early strength of typical adhesives goes up and the propensity of the profiles to warp is lower. A further factor is that the refitting time in the case of a change of profile is sharply reduced, since the flexibility of the brush hairs means that, generally speaking, a change of brush is unnecessary and there are no felts or the like to be cut to size.

The invention is described below and by way of example with reference to the drawing, in which:

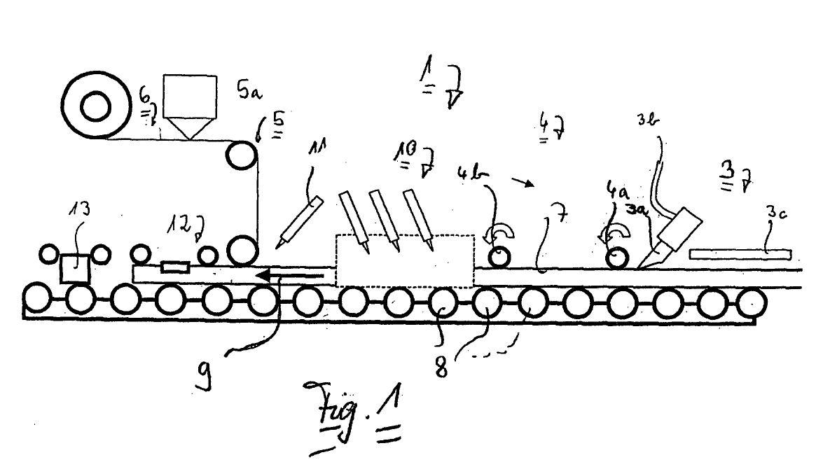

FIG. 1 shows an apparatus for adhesively bonding an article.

In accordance with FIG. 1 an apparatus generally designated by 1, intended for bonding articles, and with which an agent 2 for preparing for bonding is applied and, prior to bonding, conditioning is performed with brushing, encompasses a station 3 for applying the agent 2, a station or conditioning stage 4 with brushes 4a, 4b for conditioning prior to bonding, and a bonding stage 5, at which actual adhesive bonding is performed.

The apparatus 1 is configured in the present case as a processing station with which profiles made from PVC material are bonded with a wrapper 6, the profiles 7 being moved through beneath the various operating stations on a track of conveying rollers 8, as indicated by the arrow 9.

At the application station 3 there is a felt wiper 3a which is charged via a line 3b on its side facing away from the PVC profile with a reservoir of primer 2 as the agent for preparing for bonding, charging taking place in an amount sufficient to lead, on its side facing the PVC profile 7, to wetting at the locations where bonding is subsequently to take place. As is preferentially possible, in the embodiment depicted a preheating stage 3c is assigned in the application stage, as indicated at 3c, to the felt wiper 3a.

Following the application station 3 in the direction of movement of the profile is the conditioning stage 4. This stage encompasses two brushes 4a, 4b.

Brush 4a is arranged closely following the felt applicator. It is assigned a drive (not shown) which is designed for rotation at a comparatively low speed, such that the rotary movement is opposed to the movement on the article of the PVC profile transport direction over the conveying rollers 8. In the exemplary embodiment depicted, therefore, rotation takes place counterclockwise over the article beneath which there is movement to the left. The brush speed is chosen so that material is not spun away, or at least not far away, from the surface but instead remains in the region of contact between brush and article. The brush hair length and the distance of the centerpoint of the brushes from the article is such that there is a sufficient contact area and adequate contact between all sites on the profile, including inside hollow grooves and the like. Moreover, the denseness of the brush hairs is such that a sufficient amount of applied agent can be carried between them during rotation.

The second brush, 4b, of the conditioning stage 4 is at a distance from the first brush, 4a, in the conveying direction, this distance being sufficient to ensure a necessary degree of initial drying and/or exposure. In actual practice, with appropriate primers, distances of about 30-90 cm have proven sufficient. Like the first brush 4a, the second brush 4b is assigned a rotary drive, but the rotary drive is designed and/or controlled so as to impart to the brush 4b a substantially quicker rotation than is the case for brush 4a. In one exemplary embodiment in actual practice a rotational speed of approximately three times greater was chosen.

The brushes 4a and 4b contact the PVC profile over the entire area of primer application. The brush material is chosen so as to have long-term stability with respect to the wet primer in the case of a first brush and moist primer in the case of the second brush. Plastic brushes in particular are suitable.

Downstream of the brushes 4a and 4b is a heating tunnel 10 with dedicated fan, in which profiles are dried off and warmed to approximately 35° C.

After the profile drying stage 10 comes the adhesive bonding stage 5, where the PVC film is supplied with the hot adhesive, applied to it at a stage 5a, a temperature of more than 50° C. being achieved by means of additional hot fans 11 or the like at the contact point. The bond site is assigned an aftertreatment stage 12, at which pressing on, etc., can be performed, and also a take-away stage 13, at which the finally wrapped, bonded profile can be taken away. The latter stages are conventional per se.

The setup is used as follows:

First of all a PVC profile is gently preheated at the application station 3 in the heat-up unit 3c, and is wetted with the water-based primer 2 in excess by passing contact with a felt wiper.

Thereafter the profile traverses the short distance on the rollers 8 to the first, slow-turning brush 4a, where the applied material is evened out. Excess material is driven back in front of the brush 4a on the PVC profile 7, so that the brush 4a operates in a wet system.

In the further course of movement, initial drying takes place in the region between the brushes 4a and 4b, and the primer begins to act.

Material is then spun away from the profile, this taking place at the brush 4b. This takes place in turn over the entire width of the profile. The forces to which the profile is exposed at this point are so low that there is no permanent deformation at all.

The profile is subsequently dried off in the heating tunnel 10, warmed with the hot air fan 11, and treated with the sheet, which has been provided with hotmelt adhesive, at the contact point 5 in a manner known per se.

Comparative tests have revealed that in this way it is possible, with a low energy consumption, to achieve a very effective adhesive bond, specifically even in critical start regions and end regions of profiles. As a measure of the adhesive bonding, the peel test according to RAL 716/1 was performed using appropriate profiles. In this testing, a comparison was made between the following:
Version 1: wet felt wiper, followed by spreading with dry felt
Version 2: wet felt wiper, followed by spreading with slow-turning brush at first conditioning stage and subsequent dry-felt conditioning
Version 3: wet felt wiper, followed by spreading with slow-turning brush at first conditioning stage and subsequent conditioning stage with quick-turning brush.

The peel strengths were as follows:
Version 1: 2.8 Fr
Version 2: 3.0 Fr
Version 3: 3.2 Fr

This shows that by means of brushes it is possible to achieve a very high peel strength in sheet tearing.

1-20. (canceled)

21. A method of adhesively bonding articles, in which a water-based agent for preparing for bonding is applied to a base element, said agent ensuring that an adhesive intended for subsequent application bonds intimately to the base element, and where adhesive bonding is preceded by conditioning with brushing.

22. The method of claim 21, characterized in that at least two articles are bonded areally to one another.

23. The method of claim 21, characterized in that an article is joined at least partially to a wrapping by bonding.

24. The method of claim 21, characterized in that bonding of a profiled article takes place.

25. The method of claim 21, characterized in that bonding takes place of an elongated article which is moved past the site of application.

26. The method of claim 21, characterized in that the agent for conditioning is a primer.

27. The method of claim 21, characterized in that the agent is applied in excess.

28. The method of claim 21, characterized in that the agent is applied as a fluid.

29. The method of claim 21, characterized in that conditioning has the effect of spreading the applied agent and/or of removal.

30. The method of claim 21, characterized in that the conditioning encompasses at least two separate conditioning steps.

31. The method of claim 21, characterized in that the first conditioning step takes place in a wet system.

32. The method of claim 21, characterized in that a further conditioning step takes place in a moist system.

33. The method of claim 21, characterized in that a first conditioning step is performed for evening-out and a second conditioning step is performed for removal of excess.

34. The method of claim 21, characterized in that the brushes are moved.

35. The method of claim 21, in which at least one brush is rotated and the axis of the rotating brush is arranged generally parallel to the plane of movement.

36. The method of claim 35, characterized in that the brush circulates counter to the article's direction of movement.

37. The method of claim 21, characterized in that at least two steps of a brush conditioning take place with moving brushes and the first brush moves more slowly than the second brush.

38. The method of claim 21, in which the conditioning further encompasses a blowing-off and/or heating step.

39. The method as claimed in claim 28, wherein the fluid is a liquid.

40. The method as claimed in claim 34, wherein the brushes are moved oscillatingly and/or rotatingly over the surface of the article.
